(19) United States
(12) Patent Application Publication
(10) Pub. No.: US 2023/0283033 A1
(43) Pub. Date: Sep. 7, 2023

(54) INITIAL PRODUCT, CUTTING DEVICE AND PRODUCT MANUFACTURING METHOD

(71) Applicants: Tyco Electronics (Shanghai) Co., Ltd., Shanghai (CN); TE Connectivity Services GmbH, Schaffhausen (CH)

(72) Inventors: Jian Cao, Shanghai (CN); Lvhai (Samuel) Hu, Shanghai (CN); Dandan (Emily) Zhang, Shanghai (CN); Fengchun (Fred) Xie, Shanghai (CN); An (Joshua) Yang, Shanghai (CN); Yun (Shanghai) Liu, Shanghai (CN); Roberto Francisco-Yi Lu, Bellevue, WA (US)

(73) Assignees: Tyco Electronics (Shanghai) Co., Ltd., Shanghai (CN); TE Connectivity Services GmbH, Schaffhausen (CH)

(21) Appl. No.: 18/176,629

(22) Filed: Mar. 1, 2023

(30) Foreign Application Priority Data
Mar. 1, 2022 (CN) 202210193923.8

(51) Int. Cl. H01R 43/18; B26D 7/26; B26D 1/00

(52) U.S. Cl. CPC H01R 43/18; B26D 7/2614; B26D 1/0006; H01R 43/24

(57) ABSTRACT

A cutting device for cutting an initial product into a plurality of products comprises a base, a cutter seat and a cutter. The initial product includes an insulator and a plurality of groups of terminals fixed on the insulator. The base of the cutting device includes a plurality of slots arranged side by side, and a first positioning slot formed on an inner sidewall of each of the slots of the base and adapted to position one of the terminals of the initial product. The cutter seat is inserted into one of the plurality of slots and defines a blade slit. The cutter is adapted to be inserted into the blade slit to cut off the insulator of the initial product to form the product.

### CROSS-REFERENCE TO RELATED APPLICATIONS

This application claims the benefit of Chinese Patent Application No. CN202210193923.8 filed on Mar. 1, 2022 in the State Intellectual Property Office of China, the whole disclosure of which is incorporated herein by reference.

### FIELD OF THE INVENTION

The present invention relates to a cutting device for cutting an initial product into a plurality of products.

### BACKGROUND

According to the prior art, products such as electrical connectors and their associated components are typically manufactured separately. This leads to low production efficiency and high manufacturing cost.

Improved systems and methods for batch manufacturing products are therefore desired.

### SUMMARY

A cutting device for cutting an initial product into a plurality of products according to an embodiment of the present disclosure comprises a base, a cutter seat and a cutter. The initial product includes an insulator and a plurality of groups of terminals fixed on the insulator. The base of the cutting device includes a plurality of slots arranged side by side, and a first positioning slot formed on an inner sidewall of each of the slots of the base and adapted to position one of the terminals of the initial product. The cutter seat is inserted into one of the plurality of slots and defines a blade slit. The cutter is adapted to be inserted into the blade slit to cut off the insulator of the initial product to form the product.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 shows an illustrative perspective view of an initial product according to an exemplary embodiment of the present invention;

FIG. 2 shows an illustrative view of a product cut from an initial product according to an exemplary embodiment of the present invention, wherein the product includes a set of terminals;

FIG. 3 shows an illustrative view of a product cut from an initial product according to an exemplary embodiment of the present invention, wherein the product includes two sets of terminals;

FIG. 4 shows an illustrative perspective view of a cutting device according to an exemplary embodiment of the present invention, wherein the cutter has been inserted into the blade slit of the cutter seat;

FIG. 5 shows an illustrative perspective view of a cutting device according to an exemplary embodiment of the present invention, in which the cutter has not been inserted into the blade slit of the cutter seat;

FIG. 6 shows an illustrative perspective view of a base and a cutter seat of a cutting device according to an exemplary embodiment of the present invention;

FIG. 7 shows an illustrative perspective view of a cutter seat of a cutting device according to an exemplary embodiment of the present invention;

FIG. 8 shows an illustrative perspective view of a cutter seat and a fixed base of the cutting device according to an exemplary embodiment of the present invention; and

FIG. 9 shows an illustrative perspective view of a cutter and a cutter holder of a cutting device according to an exemplary embodiment of the present invention.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present invention, an initial product such as an electrical connector or other electric device, comprises an insulator which is integrally formed and has a length direction, and a plurality of groups of terminals which are fixed on the insulator and evenly spaced along the length direction of the insulator.

A cutting device for cutting the initial product into a plurality of products is also provided. Each of the products comprises at least one set of terminals. The cutting device comprises a base on which a plurality of slots arranged side by side are formed, a cutter seat which is inserted into the slot and formed with a blade slit, and a cutter which is adapted to be inserted into the blade slit to cut off the insulator of the initial product. A first positioning slot is formed on the inner sidewall of the slot of the base to position the terminal of the initial product. An insulator positioning notch is formed on the top of the cutter seat to position the insulator of the initial product to be cut.

According to another embodiment of the present invention, a method of manufacturing a product comprises steps of providing the above-described initial product, and cutting off the insulator of the initial product to cut the initial product into a plurality of products, each of which includes at least one set of terminals.

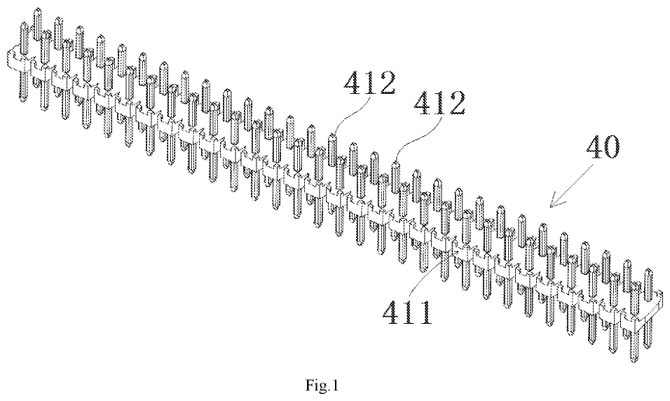

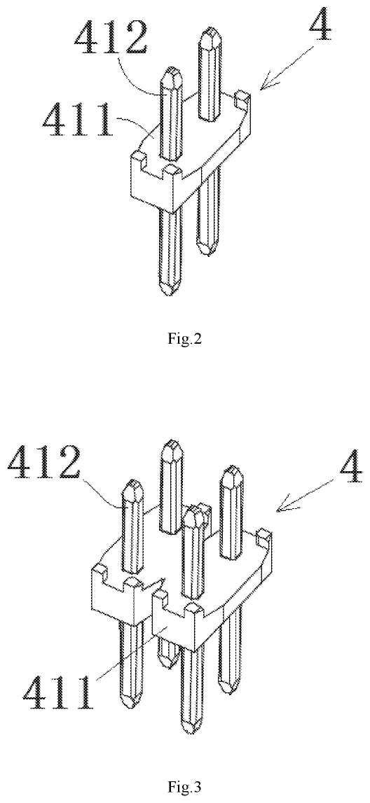

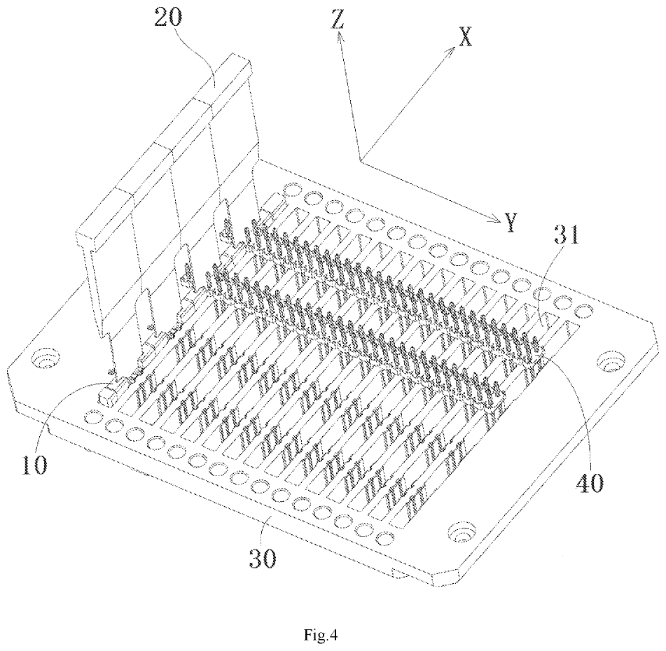

FIG. 1 shows an illustrative perspective view of an initial product 40 according to an exemplary embodiment of the present invention. FIG. 2 shows an illustrative perspective view of a product 4 cut from the initial product 40 according to an exemplary embodiment of the present invention, which includes a set of terminals 412. FIG. 3 shows an illustrative perspective view of the product 4 cut from the initial product 40 according to an exemplary embodiment of the present invention, which includes two sets of the terminals 412.

As shown in FIGS. 1-3, the initial product 40 includes an integrally formed insulator 411 and a plurality of groups of terminals 412. The insulator 411 has a length direction and a width direction. The plurality of groups of terminals 412 are fixed on the insulator 411 and evenly spaced along the length direction. In the illustrated embodiment, each group of terminals 412 includes two terminals 412 arranged side by side along the width direction of the insulator 411. However, the present invention is not limited to the illustrated embodiment, and each group of terminals 412 may include one, three or more terminals. In an exemplary embodiment of the present invention, the insulator 411 of the initial product 40 may be an integral injection molded member formed by an insertion injection molding process. During manufacturing the initial product 40, the plurality of groups of terminals 412 are first fixed in a mold, and then thermoplastic materials are injected into the mold to form the integrally molded insulator 411 of the initial product 40.

The initial product 40 can be cut into a plurality of products 4 by cutting the insulator 411. Each product 4 can include at least one set of terminals 412. For example, the product 4 may include one set of terminals 412, two sets of terminals 412, or more sets of terminals 412.

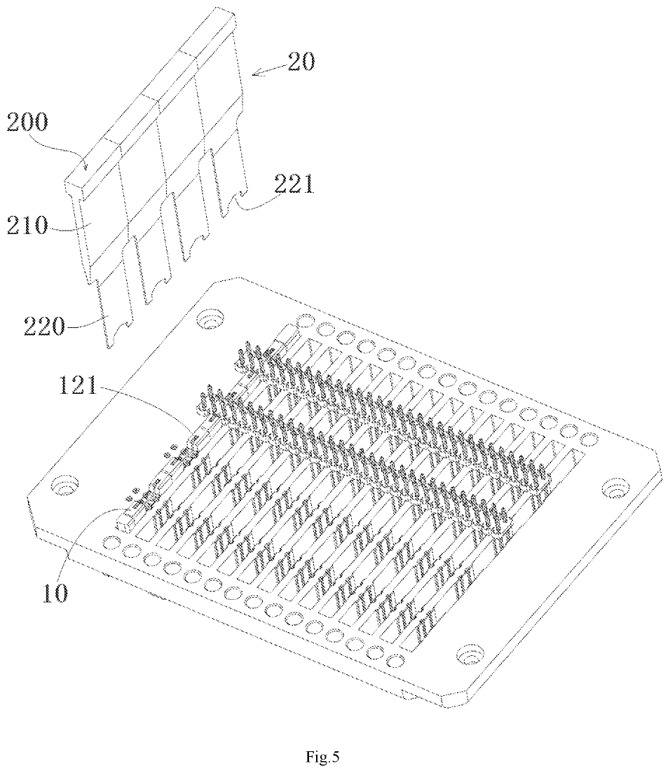

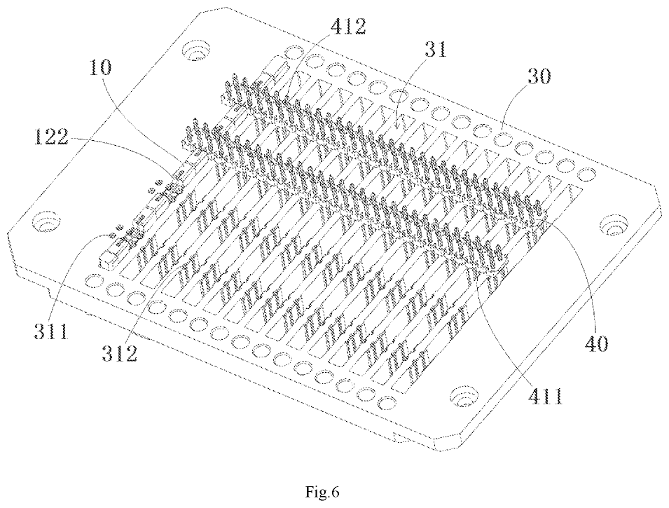

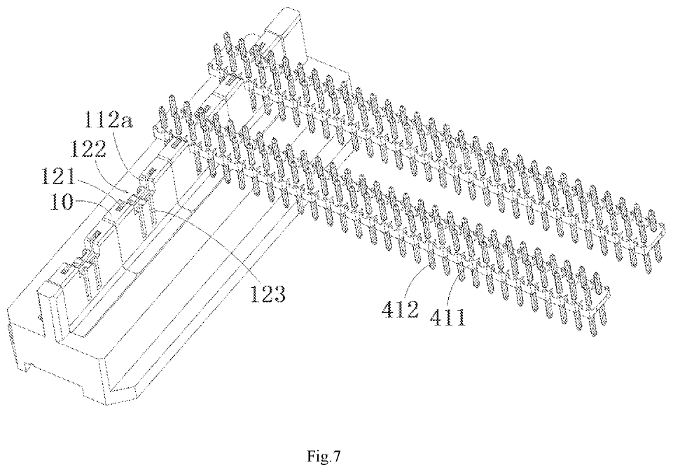

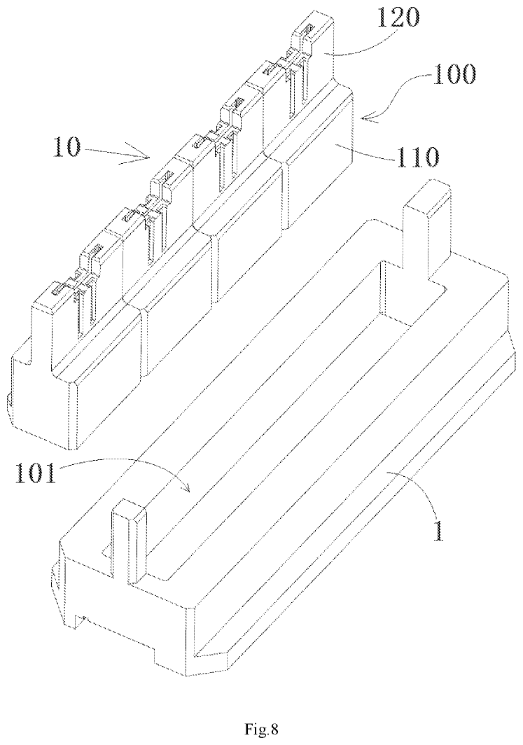

FIG. 4 shows an illustrative perspective view of a cutting device according to an exemplary embodiment of the present invention, wherein a cutter 20 has been inserted into a blade slit 121 of a cutter seat 10. FIG. 5 shows an illustrative perspective view of a cutting device according to an exemplary embodiment of the present invention, in which the cutter 20 has not been inserted into the blade slit 121 of the cutter seat 10. FIG. 6 shows an illustrative perspective view of a base 30 and the cutter seat 10 of the cutting device according to an exemplary embodiment of the present invention. FIG. 7 shows an illustrative perspective view of the cutter seat 10 of the cutting device according to an exemplary embodiment of the present invention.

As shown in FIGS. 1-7, in the illustrated embodiment, the cutting device is used to cut the initial product 40 into the plurality of products 4, each of which includes at least one set of the terminals 412. The cutting device includes the cutter seat 10, the cutter 20 and the base 30. A plurality of slots 31 arranged side by side are formed on the base 30. The cutter seat 10 is inserted into the slot 31 and is formed with the blade slit 121. The cutter 20 is adapted to be inserted into the blade slit 121 to cut off the insulator 411 of the initial product 40.

In the illustrated embodiment, a first positioning slot 312 is formed on the inner sidewall of the slot 31 of the base 30 to position the terminal 412 of the initial product 40. An insulator positioning notch 122 is formed on the top of the cutter seat 10 to position the insulator 411 of the initial product 40 to be cut. In this way, the initial product 40 to be cut can be positioned on the base 30 and the cutter seat 10, so that the initial product 40 will not be moved while being cut.

A second positioning slot 123 corresponding to the first positioning slot 312 is formed on the outer wall of the cutter seat 10. Each second positioning slot 123 cooperates with the corresponding first positioning slot 312 to position one terminal 412 of the initial product 40 to be cut.

The slot 31 and the blade slit 121 extend in the vertical direction Z and the first horizontal direction X. The first positioning slot 312 extends in the vertical direction Z. The insulator positioning notch 122 penetrates the cutter seat 10 in the second horizontal direction Y perpendicular to the first horizontal direction X. The insulator 411 of the cut initial product 40 positioned on the base 30 and the cutter seat 10 extends in the second horizontal direction Y and is supported on the top surface of the base 30.

In the illustrated embodiment, the base 30 includes a first end and a second end opposite each other in the second horizontal direction Y. The plurality of slots 31 are arranged side by side between the first end and the second end along the second horizontal direction Y. A terminal positioning hole 311 is formed on the first end of the base 30, and the terminal positioning hole 311 is used to position the terminal 412 located at the end of the initial product 40.

When the insulator 411 of the initial product 40 is positioned in the insulator positioning notch 122, two inner sides 122a of the insulator positioning notch 122 are respectively against two outer sides of the insulator 411. The bottom surface of the insulator positioning notch 122 is flush with the top surface of the base 30 to support the insulator 411 of the initial product 40 together with the top surface of the base 30.

The cutter 20 has a notch 221. An edge of the notch 221 is a cutting edge for cutting the initial product 40, and the shape of the notch 221 is arc-shaped or V-shaped to position the initial product 40 to be cut.

The cutting device also includes a driving device, which is used to drive the cutter 20 to move in the vertical direction Z, so that the cutter 20 is inserted into the blade slit 121 of the cutter seat 10 in the vertical direction Z or pulled out from the blade slit 121 of the cutter seat 10. The driving device may include a driving motor and a force amplifier. The force amplifier is connected between the cutter 20 and the driving motor, and is adapted to increase the driving force output by the driving motor.

The cutting device further includes a conveying device used to convey the base 30 and the cutter seat 10, so that the base 30 and the cutter seat 10 can be moved between a loading station and a cutting station. When the base 30 and the cutter seat 10 are moved to the loading station, the initial product 40 is loaded and positioned on the base 30 and the cutter seat 10. When the base 30 and the cutter seat 10 are moved to the cutting station, the initial product 40 loaded on the base 30 and the cutter seat 10 is cut into the required products 4 by the cutter 20. The cutting device also includes a vacuum suction device used to suck the waste generated when cutting the initial product 40.

A plurality of groups of positioning structures corresponding to a plurality of initial products 40 are formed on the base 30 and the cutter seat 10, so that the plurality of initial products 40 can be positioned and cut simultaneously. Each group of positioning structures includes the first positioning slot 312 and the insulator positioning notch 122.

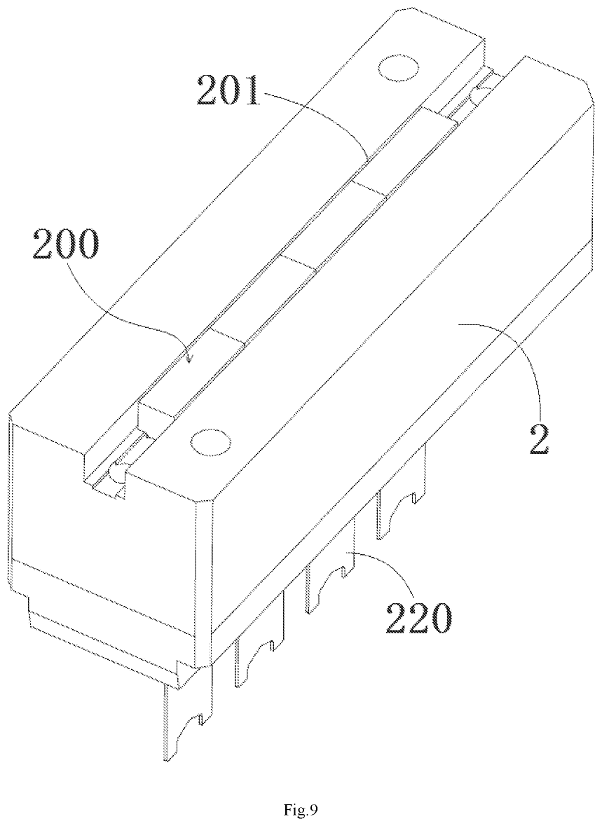

FIG. 8 shows an illustrative perspective view of the cutter seat 10 and the fixed base 1 of the cutting device according to an exemplary embodiment of the present invention. FIG. 9 shows an illustrative perspective view of the cutter 20 and the cutter holder 2 of the cutting device according to an exemplary embodiment of the present invention. In the illustrated embodiment, the cutter seat 10 includes a plurality of cutter seat units 100 arranged side by side, and each cutter seat unit 100 includes a fixing part 110 and a seat part 120. The seat part 120 is connected to the top of the fixing part 110. The seat part 120 is inserted into the slot 31 from the bottom side of the base 30 and protrudes a predetermined height from the top side of the base 30. The blade slit 121 and the insulator positioning notch 122 are formed on each seat part 120.

The cutting device further includes a fixed base 1, on which a first installation slot 101 is formed. The fixing parts 110 of a plurality of cutter seat units 100 are inserted into the first installation slot 101 of the fixed base 1.

The cutter 20 includes a plurality of cutter units 200 arranged side by side. Each cutter unit 200 includes a cutter body 210 and a cutter blade 220 connected to the cutter body 210. The cutter blade 220 is adapted to be inserted into the blade slit 121 to cut off the insulator 411 of the initial product 40.

The cutting device also includes a cutter holder 2, on which a second installation slot 201 is formed. The cutter bodies 210 of the plurality of cutter units 200 are inserted into the second installation slot 201 of the cutter holder 2.

As shown in FIGS. 1-9, in an exemplary embodiment of the present invention, a product manufacturing method is also disclosed. The method may comprise the following steps of:
S100: providing the above initial product 40; and
S200: cutting off the insulator 411 of the initial product 40 to cut the initial product 40 into multiple products 4, each of which includes at least one set of terminals 412.

The step S200 may comprise the steps of:
S210: providing the aforementioned cutting device; and
S220: using the cutting device to cut the initial product 40 into multiple products 4.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A cutting device for cutting an initial product, including an insulator and a plurality of groups of terminals fixed on the insulator, into a plurality of products, comprising:
a base, defining:
a plurality of slots arranged side by side; and
a first positioning slot formed on an inner sidewall of each of the slots of the base and adapted to position one of the terminals of the initial product;
a cutter seat inserted into one of the plurality of slots and defining a blade slit; and
a cutter adapted to be inserted into the blade slit to cut the insulator of the initial product to form the product.

2. The cutting device according to claim 1, further comprising an insulator positioning notch formed on a top of the cutter seat and adapted to position the insulator of the initial product to be cut.

3. The cutting device according to claim 2, further comprising a second positioning slot corresponding to the first positioning slot formed on an outer sidewall of the cutter seat, the second positioning slot cooperating with the corresponding first positioning slot to position the terminal of the initial product to be cut.

4. The cutting device according to claim 3, wherein the slot and the blade slit extend in a vertical direction and a first horizontal direction, the first positioning slot extends in the vertical direction, and the insulator positioning notch penetrates through the cutter seat in a second horizontal direction perpendicular to the first horizontal direction.

5. The cutting device according to claim 4, wherein the base comprises a first end and a second end opposite each other in the second horizontal direction, the plurality of slots are arranged side by side between the first end and the second end along the second horizontal direction.

6. The cutting device according to claim 5, wherein a terminal positioning hole is formed in the first end of the base and is adapted to position the terminal located at an end of the initial product.

7. The cutting device according to claim 5, wherein when the insulator of the initial product to be cut is positioned in the insulator positioning notch, two inner sides of the insulator positioning notch are adapted to abut against two respective outer sides of the insulator.

8. The cutting device according to claim 5, wherein a bottom surface of the insulator positioning notch is flush with a top surface of the base.

9. The cutting device according to claim 2, wherein a plurality of groups of positioning structures corresponding to a plurality of initial products are formed on the base and the cutter seat.

10. The cutting device according to claim 9, wherein each group of positioning structures includes the first positioning slot and the insulator positioning notch.

11. The cutting device according to claim 10, wherein the cutter seat comprises a plurality of cutter seat units arranged side by side, each cutter seat unit including:
a fixing part; and
a seat part connected to the top of the fixing part, the seat part is inserted into the slot from a bottom side of the base and protrudes a predetermined height from a top side of the base.

12. The cutting device according to claim 11, wherein each seat part is formed with the blade slit and the insulator positioning notch.

13. The cutting device according to claim 12, further comprising a fixed base on which a first installation slot is formed, the fixing parts of the plurality of cutter seat units are inserted into the first installation slot of the fixed base.

14. The cutting device according to claim 13, wherein the cutter comprises a plurality of cutter units arranged side by side.

15. The cutting device according to claim 14, wherein each cutter unit comprises:
a cutter body; and
a cutter blade connected to the cutter body, the cutter blade is adapted to be inserted into the blade slit to cut off the insulator of the initial product.

16. The cutting device according to claim 15, further comprising a cutter holder on which a second installation slot is formed, the cutter bodies of the plurality of cutter units are inserted into the second installation slot of the cutter holder.

17. The cutting device according to claim 1, wherein the cutter has a notch, the edge of the notch defining a cutting edge adapted to cut the initial product.

18. The cutting device according to claim 17, wherein the notch is arc-shaped or V-shaped and adapted to position the initial product to be cut.

19. A method of manufacturing a product, comprising steps of:
providing an initial product including an insulator and a plurality of groups of terminals fixed on the insulator and evenly spaced along a length direction thereof; and
cutting off the insulator of the initial product to cut the initial product into a plurality of the products, each of which includes at least one set of terminals.

20. The method according to claim 19, wherein the step of cutting off the insulator is performed with a cutting device, including:
a base having a plurality of slots arranged side by side and a first positioning slot formed on an inner sidewall of each of the slots of the base and adapted to position one of the terminals of the initial product;
a cutter seat inserted into one of the plurality of slots and defining a blade slit; and
a cutter adapted to be inserted into the blade slit to cut off the insulator of the initial product to form the product.
